(19) United States
(12) Patent Application Publication
(10) Pub. No.: US 2006/0018242 A1
(43) Pub. Date: Jan. 26, 2006

(54) Multilayer information recording medium and method for manufacturing the same

(75) Inventors: Morio Tomiyama, Ikoma-shi (JP); Keiji Nishikiori, Yawata-shi (JP); Yuuko Tomekawa, Ibaraki-shi (JP)

Correspondence Address: HAMRE, SCHUMANN, MUELLER & LARSON P.C., P.O. BOX 2902, MINNEAPOLIS, MN, 55402, US

(73) Assignee: MATSUSHITA ELECTRIC INDUSTRIAL CO., LTD., KADOMA-SHI (JP)

(21) Appl. No.: 11/185,421

(22) Filed: Jul. 20, 2005

(30) Foreign Application Priority Data
Jul. 21, 2004 (JP) 2004-212711
Jan. 19, 2005 (JP) 2005-011203

(51) Int. Cl. G11B 7/26; B29C 65/00; B32B 37/00

(52) U.S. Cl. 369/272.1; 156/307.1; 156/344

(57) ABSTRACT

A method for manufacturing a multilayer information recording medium including a signal substrate, at least two information recording portions disposed on the signal substrate and a resin layer disposed between the information recording portions adjacent to each other is provided. The method includes forming the resin layer, and in the forming of the resin layer, a resin-containing coating is applied onto the signal substrate except for edge portions and of the signal substrate through openings of a screen, the signal substrate and a signal transfer substrate are attached to each other via the applied resin-containing coating at a pressure lower than atmospheric pressure, a resin contained in the applied resin-containing coating is cured to form the resin layer, and then the signal transfer substrate is peeled off from the resin layer.

### BACKGROUND OF THE INVENTION

1. Field of the Invention

The present invention relates to a multilayer information recording medium for recording information or reproducing information and a method for manufacturing the same.

2. Description of Related Art

In recent years, with an increase in the amount of information processed in information equipment, audiovisual equipment or the like, attention has been directed to an information recording medium such as an optical disk allowing easy data access and capable of storing large volumes of data and responding to the miniaturization of equipment. Also, the higher-density recording of information in an information recording medium has been studied. As an information recording medium capable of high-density recording, an information recording medium with respect to which information is recorded/reproduced using a recording/reproducing apparatus provided with an optical head including a laser light source with a wavelength of about 400 nm and a focusing lens with a numerical aperture (NA) of 0.85 has been suggested (see JP 2002-092969 A, for example). In this information recording medium, it is possible to store data with a capacity of about 25 GB for a single recording layer and about 50 GB for two recording layers, for example.

Now, the structure and manufacturing method of a conventional multilayer information recording medium described in JP 2002-092969 A will be described with reference to FIGS. 7A to 9J.

FIGS. 7A to 7F show a method for manufacturing a substrate production die (stamper) used when producing the conventional multilayer information recording medium. First, a photosensitive material such as photoresist is applied onto a glass plate 201, thereby forming a photosensitive film 202 (see FIG. 7A). Then, using a laser beam 203, an exposure is performed for transferring a pattern of pits and guide grooves to the photosensitive film 202 (see FIG. 7B). In FIG. 7B, numeral 202a denotes a portion irradiated with the laser beam 203 (an exposed portion). The photosensitive material in the exposed portion undergoes a developing process so as to be removed, so that an optical recording master 205 in which a pattern 204 of pits and guide grooves are formed on the glass plate 201 is obtained (see FIG. 7C). Next, an electrically conductive film 206 is formed on the pattern 204 by sputtering, vapor deposition or the like. This transfers the shape of the pattern 204 onto the electrically conductive film 206 (see FIG. 7C and FIG. 7D). Subsequently, a plating film 207 is formed on the electrically conductive film 206, thereby increasing the rigidity and thickness of the electrically conductive film 206 (see FIG. 7E). Thereafter, a laminate of the plating film 207 and the electrically conductive film 206 is peeled off from the optical recording master 205, thus obtaining a stamper 208 (see FIG. 7F).

FIG. 8 is a sectional view showing the conventional multilayer information recording medium. This multilayer information recording medium includes a first signal substrate 301. A first information recording portion 302 is disposed on the first signal substrate 301, and a second signal substrate 303 is disposed on the first information recording portion 302. A second information recording portion 304, a transparent layer 305 and a transparent substrate 306 are disposed in this order on the second signal substrate 303. The transparent layer 305 is provided for attaching the transparent substrate 306 to the second information recording portion 304.

The first signal substrate 301 has a surface with pits and guide grooves serving as an uneven information surface. This information surface is formed when molding the first signal substrate 301 by an injection compression molding using the stamper 208 shown in FIG. 7F. The average thickness of the first signal substrate 301 is about 1.1 mm. The first information recording portion 302 and the second information recording portion 304 each include a recording film, a reflecting film, etc., and are formed by sputtering, vapor deposition or the like.

The second signal substrate 303 is formed by attaching a signal transfer substrate having an uneven surface to a photocurable resin applied by spin-coating, curing the photocurable resin and then peeling off the signal transfer substrate from the photocurable resin. The signal transfer substrate has an uneven surface similarly to the stamper 208 shown in FIG. 7F.

The transparent substrate 306 is formed of a material that is transparent to (adequately transmits) recording/reproducing light. The transparent layer 305 is formed of a photocurable resin and an adhesive such as a pressure-sensitive adhesive. The average thickness of the sum of the transparent substrate 306 and the transparent layer 305 is about 0.075 mm. With respect to thus produced multilayer information recording medium, information is recorded/reproduced by allowing a recording/reproducing laser beam to enter from the side of the transparent substrate 306.

The following is a more detailed description of the method for manufacturing the conventional multilayer information recording medium using FIGS. 9A to 9J.

First, a first information recording portion 402 is formed on an information surface of a first signal substrate 401 by sputtering, vapor deposition or the like. The first signal substrate 401 is kept fixed to a rotation table 403 by suction or the like (see FIG. 9A). Next, onto the first information recording portion 402, a coating 404 containing a photocurable resin is applied in such a manner as to form a circle with a desired radius using a dispenser (see FIG. 9B). Then, the rotation table 403 is rotated, thereby spreading the coating 404. At the time of spreading, any excess resin and air bubbles are removed by centrifugal force. The spread coating 404 can be controlled to have a desired thickness by setting the viscosity of the coating 404, the number of revolutions of the rotation table, the period for rotating the same and the atmosphere conditions (temperature, humidity etc.) optionally. After the rotation, the coating 404 is cured by light irradiation using a light irradiator 405, thus obtaining a photocurable resin layer 404′ (see FIG. 9C).

On the other hand, a signal transfer substrate 406 is fixed onto a rotation table 407. The signal transfer substrate 406 has an uneven surface similar to the stamper 208 shown in FIG. 7F (see FIG. 9D). Onto the signal transfer substrate 406, a coating 408 containing a photocurable resin is applied in such a manner as to form a circle with a desired radius using a dispenser. Then, the rotation table 407 is rotated, thereby spreading the coating 408. The thickness of the spread coating 408 can be controlled similarly to the case of the coating 404 (see FIG. 9E). After the rotation table 407 is stopped, the coating 408 is cured by light irradiation using a light irradiator 409, thus obtaining a photocurable resin layer 408′ (see FIG. 9F).

Subsequently, on the rotation table 403, a substrate 410 and a substrate 411 are stacked via a coating 412 containing a photocurable resin such that the photocurable resin layers 408′ and 404′ face each other. In this state, the rotation table 403 is rotated (see FIG. 9G). By the rotation of the rotation table 403, the coating 412 is controlled (spread) to have a desired thickness. Thereafter, the coating 412 is cured by light irradiation using the light irradiator 405, thus obtaining a photocurable resin layer 412′ (see FIG. 9H). Then, the signal transfer substrate 406 is peeled off from the photocurable resin layer 408′.

It should be noted that the photocurable resin contained in the coating 404 is selected from resins having an excellent adhesiveness to the first information recording portion 402 and the photocurable resin layer 412′. The photocurable resin contained in the coating 408 is selected from resins having an excellent peelability from the signal transfer substrate 406 and an excellent adhesiveness to the photocurable resin layer 412′. The viscosities of the coating 404, 412 and 408 are all adjusted to be about 150 mPa·s so that a thin photocurable resin layer can be formed. Incidentally, an integral body of the photocurable resin layers 404′, 408′ and 412′ (also referred to as a resin layer) corresponds to the second signal substrate 303 in FIG. 8. For convenience of description, the above-noted integral body is illustrated to be thicker than the second signal substrate 303 in FIG. 8.

Next, a second information recording portion 413 is formed on a surface of the photocurable resin layer 408′ opposite to the side of the first signal substrate 401, namely, a second information surface by sputtering, vapor deposition or the like. On the second information recording portion 413, a coating containing a photocurable resin is applied for forming a transparent layer 415. Then, after a transparent substrate 414 is attached to the applied coating, the rotation table 403 is rotated, thereby removing air bubbles mixed into the coating and spreading the coating. Thereafter, the coating is irradiated with light having a desired wavelength through the transparent substrate 414, thus curing the photocurable resin. Thus, the coating is formed into the transparent layer 415 (see FIG. 9I).

However, when the photocurable resin layer, etc. are formed by spin-coating, a slight variation in film thickness in a peripheral direction and a large variation in film thickness in a radial direction are generated. In particular, in a multilayer information recording medium including a large number of information recording portions, the variations in film thickness of the signal substrate (resin layer) disposed between adjacent information recording portions add up to a large variation in thickness of the entire multilayer information recording medium.

Also, by spin-coating, the coating reaches edge portions (an outer edge portion in the example shown in FIG. 8) of the coated surface. Therefore, when curing the photocurable resin by light irradiation, the photocurable resin on the edge portions is mounded by a surface tension, so that the photocurable resin layer 404′ becomes considerably thicker on the edge portions of the coated surface than on the other portion of the coated surface (see FIG. 9J). Such a variation in thickness causes the variation in thickness of the integral body (resin layer) of the photocurable resin layers 404′, 408′ and 412′. The variation in thickness of the resin layer leads to a variation in a light spot size due to an increase in a spherical aberration at the time of recording or reproducing information using a laser beam. Furthermore, the above-noted variation in thickness adversely affects a focusing control for maintaining a focus of a light spot on an information surface or a tracking control for allowing the light spot to follow a signal train. As a result, there arises a problem in that information cannot be recorded on or reproduced from the multilayer information recording medium excellently.

Further, in order to suppress the above-noted variation in thickness in spin-coating, it is necessary to produce a complicated program for controlling the rotation speed, the number of revolutions and the like of the rotation table. Thus, when attempting to suppress the above-noted variation in thickness in spin-coating, there arises a problem in that a tact time (a time required to produce one product) increases.

It is an object of the present invention to provide a multilayer information recording medium with respect to which information is reproduced or recorded/reproduced excellently and that achieves an excellent production efficiency, and a method for manufacturing the same.

### SUMMARY OF THE INVENTION

A first method for manufacturing a multilayer information recording medium according to the present invention is a method for manufacturing a multilayer information recording medium having a signal substrate, at least two information recording portions disposed on the signal substrate and a resin layer disposed between the information recording portions adjacent to each other. The method includes forming the resin layer. The forming of the resin layer includes applying a resin-containing coating onto the signal substrate except for an edge portion of the signal substrate through openings of a screen, attaching the signal substrate and a signal transfer substrate to each other via the applied resin-containing coating at a pressure lower than atmospheric pressure, curing a resin contained in the applied resin-containing coating to form the resin layer, and then peeling off the signal transfer substrate from the resin layer.

A second method for manufacturing a multilayer information recording medium according to the present invention is a method for manufacturing a multilayer information recording medium having a signal substrate, at least two information recording portions disposed on the signal substrate and a resin layer disposed between the information recording portions adjacent to each other. The method includes forming the resin layer. The forming of the resin layer includes applying a resin-containing coating onto a signal transfer substrate except for an edge portion of the signal transfer substrate through openings of a screen, attaching the signal substrate and the signal transfer substrate to each other via the applied resin-containing coating at a pressure lower than atmospheric pressure, curing a resin contained in the applied resin-containing coating to form the resin layer, and then peeling off the signal transfer substrate from the resin layer.

A third method for manufacturing a multilayer information recording medium according to the present invention is a method for manufacturing a multilayer information recording medium having a signal substrate, at least two information recording portions disposed on the signal substrate and a resin layer disposed between the information recording portions adjacent to each other. The method includes forming the resin layer. The forming of the resin layer includes applying a first resin-containing coating onto a signal transfer substrate except for an edge portion of the signal transfer substrate through openings of a first screen, applying a second resin-containing coating onto the signal substrate except for an edge portion of the signal substrate through openings of a second screen, attaching the signal substrate and the signal transfer substrate to each other via the first and second resin-containing coatings at a pressure lower than atmospheric pressure, curing a resin contained in the first resin-containing coating and a resin contained in the second resin-containing coating to form the resin layer, and then peeling off the signal transfer substrate from the resin layer.

### BRIEF DESCRIPTION OF THE DRAWINGS

FIG. 1 is a sectional view showing an example of a multilayer information recording medium according to an embodiment of the present invention.

FIG. 2 is an enlarged view showing a first information recording portion of the multilayer information recording medium shown in FIG. 1.

FIG. 3A is a sectional view for describing an example of a method for manufacturing a multilayer information recording medium according to an embodiment of the present invention.

FIG. 3B is a sectional view for describing an example of the method for manufacturing a multilayer information recording medium according to an embodiment of the present invention.

FIG. 3C is a sectional view for describing an example of the method for manufacturing a multilayer information recording medium according to an embodiment of the present invention.

FIG. 3D is a sectional view for describing an example of the method for manufacturing a multilayer information recording medium according to an embodiment of the present invention.

FIG. 4A is a sectional view for describing an example of the method for manufacturing a multilayer information recording medium according to an embodiment of the present invention.

FIG. 4B is a sectional view for describing an example of the method for manufacturing a multilayer information recording medium according to an embodiment of the present invention.

FIG. 4C is a sectional view for describing an example of the method for manufacturing a multilayer information recording medium according to an embodiment of the present invention.

FIG. 4D is a sectional view for describing an example of the method for manufacturing a multilayer information recording medium according to an embodiment of the present invention.

FIG. 5A is a graph showing a result of measuring the thickness of a resin layer constituting the multilayer information recording medium according to an embodiment of the present invention.

FIG. 5B is a graph showing a result of measuring the thickness of a resin layer constituting a conventional multilayer information recording medium.

FIG. 6A is a sectional view for describing another example of the method for manufacturing a multilayer information recording medium according to an embodiment of the present invention.

FIG. 6B is a sectional view for describing another example of the method for manufacturing a multilayer information recording medium according to an embodiment of the present invention.

FIG. 6C is a sectional view for describing another example of the method for manufacturing a multilayer information recording medium according to an embodiment of the present invention.

FIG. 6D is a sectional view for describing another example of the method for manufacturing a multilayer information recording medium according to an embodiment of the present invention.

FIG. 6E is a sectional view for describing another example of the method for manufacturing a multilayer information recording medium according to an embodiment of the present invention.

FIG. 7A is a sectional view for describing an example of a method for manufacturing a substrate production die used when producing a conventional multilayer information recording medium.

FIG. 7B is a sectional view for describing an example of the method for manufacturing the substrate production die used when producing the conventional multilayer information recording medium.

FIG. 7C is a sectional view for describing an example of the method for manufacturing the substrate production die used when producing the conventional multilayer information recording medium.

FIG. 7D is a sectional view for describing an example of the method for manufacturing the substrate production die used when producing the conventional multilayer information recording medium.

FIG. 7E is a sectional view for describing an example of the method for manufacturing the substrate production die used when producing the conventional multilayer information recording medium.

FIG. 7F is a sectional view for describing an example of the method for manufacturing the substrate production die used when producing the conventional multilayer information recording medium.

FIG. 8 is a sectional view for describing an example of a conventional multilayer information recording medium.

FIG. 9A is a sectional view for describing an example of a method for manufacturing a conventional multilayer information recording medium.

FIG. 9B is a sectional view for describing an example of the method for manufacturing a conventional multilayer information recording medium.

FIG. 9C is a sectional view for describing an example of the method for manufacturing a conventional multilayer information recording medium.

FIG. 9D is a sectional view for describing an example of the method for manufacturing a conventional multilayer information recording medium.

FIG. 9E is a sectional view for describing an example of the method for manufacturing a conventional multilayer information recording medium.

FIG. 9F is a sectional view for describing an example of the method for manufacturing a conventional multilayer information recording medium.

FIG. 9G is a sectional view for describing an example of the method for manufacturing a conventional multilayer information recording medium.

FIG. 9H is a sectional view for describing an example of the method for manufacturing a conventional multilayer information recording medium.

FIG. 9I is a sectional view for describing an example of the method for manufacturing a conventional multilayer information recording medium.

FIG. 9J is a partially enlarged view of FIG. 9C.

### DETAILED DESCRIPTION OF THE INVENTION

According to the first to third methods for manufacturing a multilayer information recording medium, it is possible, regarding the resin layer for separating the adjacent information recording portions, to suppress mounding of the resin layer on the edge portion of the signal substrate, so that a multilayer information recording medium with suppressed thickness variation can be provided. Therefore, it is possible to suppress the variation in light spot size due to an increase in a spherical aberration, thus providing a multilayer information recording medium that performs a focusing control and a tracking control stably. In other words, a multilayer information recording medium with respect to which information is recorded or reproduced excellently can be provided.

Also, in the first to third methods for manufacturing a multilayer information recording medium, since the signal substrate and the signal transfer substrate are attached to each other at a pressure lower than atmospheric pressure, the entry of air bubbles into the resin layer is suppressed, so that the entry of air bubbles into an optical path is suppressed. This also suppresses the variation in light spot size due to an increase in a spherical aberration in a multilayer information recording medium produced by the above-mentioned first to third manufacturing methods. This allows a focusing control and a tracking control to be performed stably.

Further, in the first to third methods for manufacturing a multilayer information recording medium, since there is no need for a complicated program for controlling the rotation speed, the number of revolutions and the like of the rotation table, the tact time (a time required to produce one product) can be made shorter than in the case of forming the resin layer by spin-coating, so that an excellent production efficiency is achieved. In addition, in the first to third methods for manufacturing a multilayer information recording medium, since the resin-containing coating is applied by screen printing, the resin layer with a more uniform thickness can be formed more speedily than in the case of applying the resin-containing coating by spin-coating.

As described above, in accordance with the first to third methods for manufacturing a multilayer information recording medium, a multilayer information recording medium with respect to which information is recorded or reproduced excellently can be provided with excellent productivity.

In the first to third methods for manufacturing a multilayer information recording medium, it is preferable that in the forming of the resin layer, the signal substrate and the signal transfer substrate are attached to each other after a predetermined period of time from the time the resin-containing coating is applied. This is because the unevenness on the surface of the resin-containing coating that has been applied through the openings of the screen is smoothed out naturally within the above-noted predetermined period of time, making it possible to attach the signal substrate and the signal transfer substrate to each other in an excellent manner.

In the first to third methods for manufacturing a multilayer information recording medium, it is preferable that the forming of the resin layer further includes heating the resin-containing coating that has been applied to the signal substrate after applying of the resin-containing coating and before attaching the signal substrate and the signal transfer substrate to each other. This is because the unevenness on the surface of the resin-containing coating that has been applied can be smoothed out speedily.

It is preferable that the applied resin-containing coating is heated so that its surface temperature rises to 40° C. to 120° C. This is because the efficiency in smoothing out the resin-containing coating can be improved while suppressing the warping of the multilayer information recording medium due to heating. For the similar reason, it is further preferable that the applied resin-containing coating is heated so that its surface temperature rises to 40° C. to 100° C.

In the first to third methods for manufacturing a multilayer information recording medium, it is preferable that the forming of the resin layer further includes heating the resin-containing coating with a hot air in the middle of applying the resin-containing coating. Also, it is preferable that the applied resin-containing coating is heated with a hot air. This is because the combination of heating and blowing an air makes it possible to smooth out the surface of the resin-containing coating more efficiently and effectively and suppress the entry of large air bubbles into the resin layer. It is preferable that the resin-containing coating is heated with the hot air so that its surface temperature rises to 30° C. to 100° C.

The resin contained in the resin-containing coating preferably contains a photocurable resin, and the photocurable resin preferably is an ultraviolet curable resin, for example. The ultraviolet curable resin responds with a high sensitivity only to light at wavelengths in an ultraviolet range and cures itself Therefore, in a process of forming the resin layer, even if the applied resin-containing coating (containing the ultraviolet curable resin) is heated using electromagnetic waves in a wavelength range longer than the ultraviolet light, the ultraviolet curable resin is not cured by these electromagnetic waves. Thus, by heating the resin-containing coating using the electromagnetic waves in the wavelength range longer than the ultraviolet light, it becomes possible to smooth out the surface of the applied resin-containing coating speedily without curing the ultraviolet curable resin.

In the case where the resin contained in the resin-containing coating contains the ultraviolet curable resin, it is preferable that the applied resin-containing coating is heated with an electromagnetic wave in a wavelength range longer than ultraviolet light. This is because the surface of the resin-containing coating can be smoothed out without curing the ultraviolet curable resin.

It is preferable that the resin-containing coating to be applied has a viscosity of 30 to 4000 mPa·s (30 to 4000 cps). This is because it becomes possible both to apply the resin-containing coating through the openings of the screen excellently and to suppress the flowing of the resin-containing coating applied onto the signal substrate into the edge portion of the signal substrate, thus suppressing the mounding of the resin layer in the edge portion. For the similar reason, it is further preferable that the resin-containing coating to be applied has a viscosity of 100 to 4000 mPa·s (100 to 4000 cps).

In the first to third methods for manufacturing a multilayer information recording medium, it is preferable that the forming of the resin layer further includes pressing the signal transfer substrate with a pressing system after attaching the signal substrate and the signal transfer substrate to each other and before curing the resin contained in the applied resin-containing coating. This is because the signal can be transferred in an excellent manner.

In the case where the resin contained in the resin-containing coating contains the photocurable resin, it is preferable that the signal transfer substrate is transparent to an irradiation light used for curing the resin, and the resin-containing coating is irradiated with the irradiation light through the signal transfer substrate, thus curing the photocurable resin. This is because such a method makes it possible to form the resin layer easily and efficiently.

In the case where the photocurable resin contained in the resin-containing coating is the ultraviolet curable resin, the irradiation light used for curing the ultraviolet curable resin is appropriate as long as its wavelength range is in the ultraviolet range.

In the first to third methods for manufacturing a multilayer information recording medium, in the case where the resin-containing coating contains the ultraviolet curable resin, it is preferable that the signal transfer substrate contains polyolefin. This is because, since polyolefin is a material having excellent peelability from the ultraviolet curable resin, it is possible to peel off the signal transfer substrate from the resin layer with a small force and to suppress the adhesion of resin to the signal transfer substrate.

In the first and second methods for manufacturing a multilayer information recording medium, it is preferable that the signal substrate is a disc having a center hole, and in the forming of the resin layer, the resin-containing coating is applied onto the signal substrate except for an outer edge portion and an inner edge portion of the signal substrate.

In the third method for manufacturing a multilayer information recording medium, it is preferable that the signal substrate and the signal transfer substrate are formed as a disc having a center hole, and in the forming of the resin layer, the first resin-containing coating is applied onto the signal transfer substrate except for an outer edge portion and an inner edge portion of the signal transfer substrate and the second resin-containing coating is applied onto the signal substrate except for an outer edge portion and an inner edge portion of the signal substrate.

Since an information recording medium according to an embodiment of the present invention is manufactured by the first to third methods for manufacturing a multilayer information recording medium, the variation in thickness of the resin layer is small. Accordingly, the variation in an optical path length from the surface of the multilayer information recording medium on a light incident side to each information surface also is small. Also, in the information recording medium according to an embodiment of the present invention, the variation in light spot size due to an increase in a spherical aberration can be suppressed, and a focusing control and a tracking control can be performed stably. Therefore, in the information recording medium according to the present invention, information can be recorded or reproduced excellently.

The following is a description of embodiments of the present invention, with reference to the accompanying drawings. Although the present embodiments will describe a so-called Blu-ray Disc as an example of a multilayer information recording medium, a multilayer information recording medium in the present invention is not limited to this but may be a memory card, a CD or a DVD, for example.

### Embodiment 1

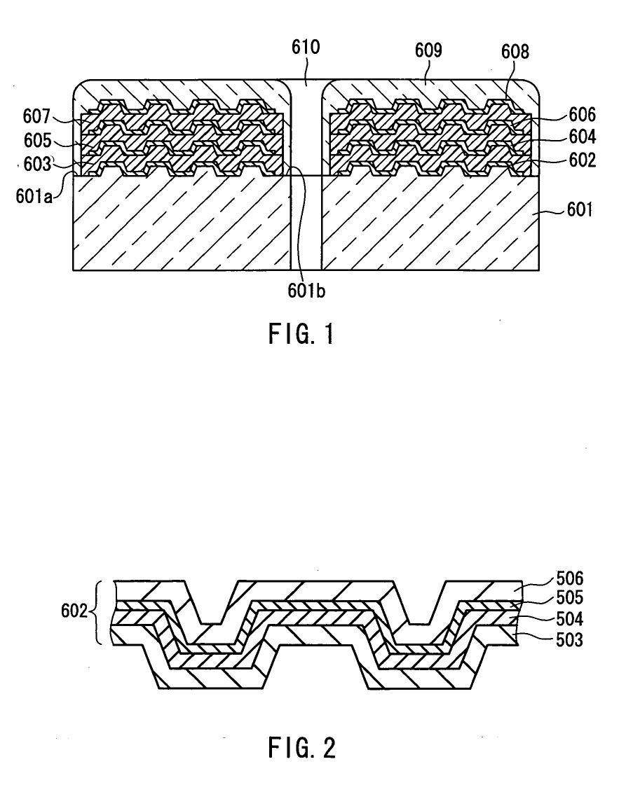

FIG. 1 is a sectional view showing a multilayer information recording medium in the present embodiment. As shown in FIG. 1, the multilayer information recording medium includes a first signal substrate 601 and a first information recording portion 602 disposed on an information surface of the first signal substrate 601. The first signal substrate 601 has a surface with pits and guide grooves serving as an uneven information surface. Also, the multilayer information recording medium includes a second signal substrate 603 disposed on the first information recording portion 602. The second signal substrate 603 has a surface with pits and guide grooves serving as an uneven information surface (a surface on a side opposite to the first signal substrate 601). The multilayer information recording medium includes a second information recording portion 604 disposed on this information surface. The multilayer information recording medium includes a third signal substrate 605 disposed on the second information recording portion 604. The third signal substrate 605 has a surface with pits and guide grooves serving as an uneven information surface (a surface on a side opposite to the second signal substrate 603). The multilayer information recording medium includes a third information recording portion 606 disposed on this information surface. The multilayer information recording medium includes a fourth signal substrate 607 disposed on the third information recording portion 606. The fourth signal substrate 607 has a surface with pits and guide grooves serving as an uneven information surface (a surface on a side opposite to the third signal substrate 605). The multilayer information recording medium includes a fourth information recording portion 608 disposed on this information surface and a transparent layer 609 disposed on the fourth information recording portion 608.

Incidentally, in the present application, the second to fourth signal substrates 603, 605 and 607 also are referred to as resin layers 603, 605 and 607.

The first signal substrate 601 is formed as a disc having an outer diameter φ of 120 mm and an average thickness of 1.1 mm in order to suppress the warping of the information recording medium, increase the rigidity thereof and secure the compatibility with other optical disks such as CDs and DVDs. The material for the first signal substrate 601 can be, for example, polycarbonate or acrylic resin. In the multilayer information recording medium shown in FIG. 1, polycarbonate is used as the material for the first signal substrate 601.

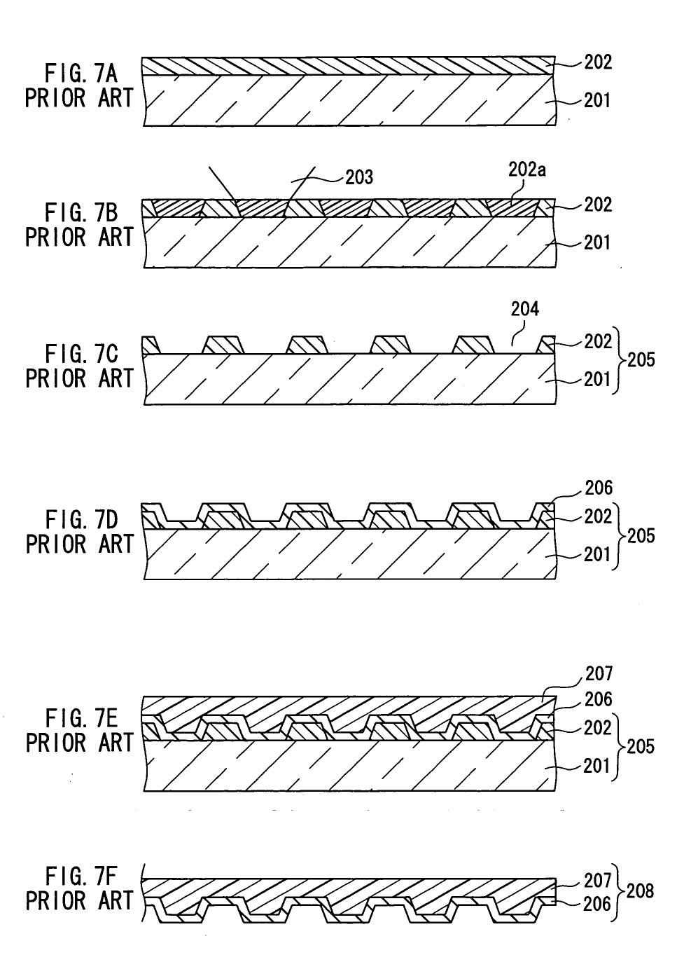

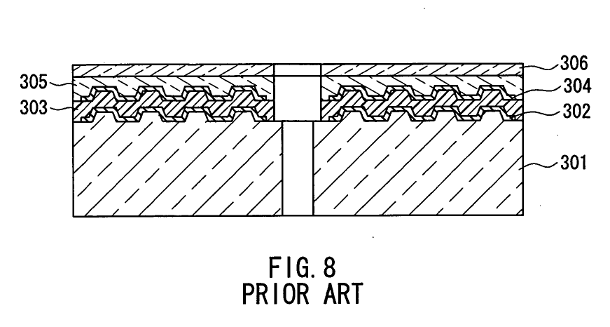

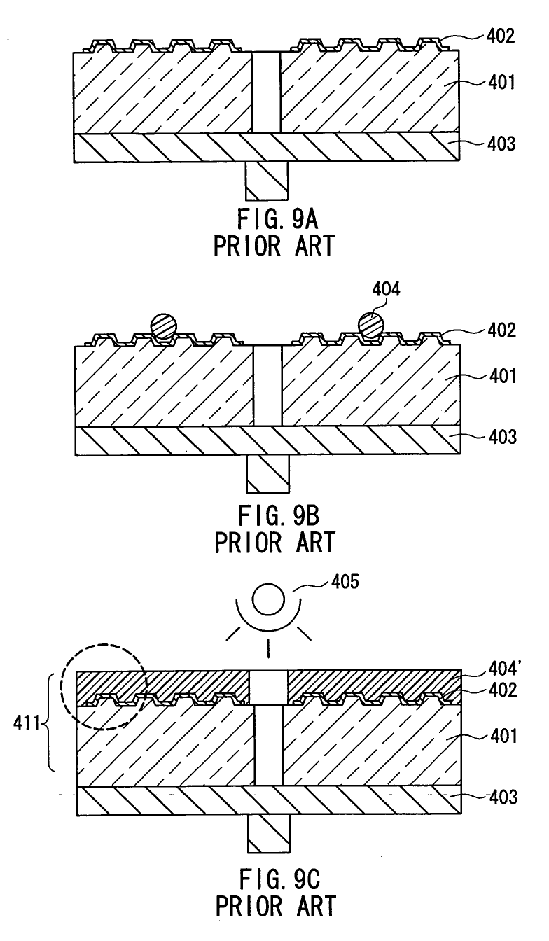

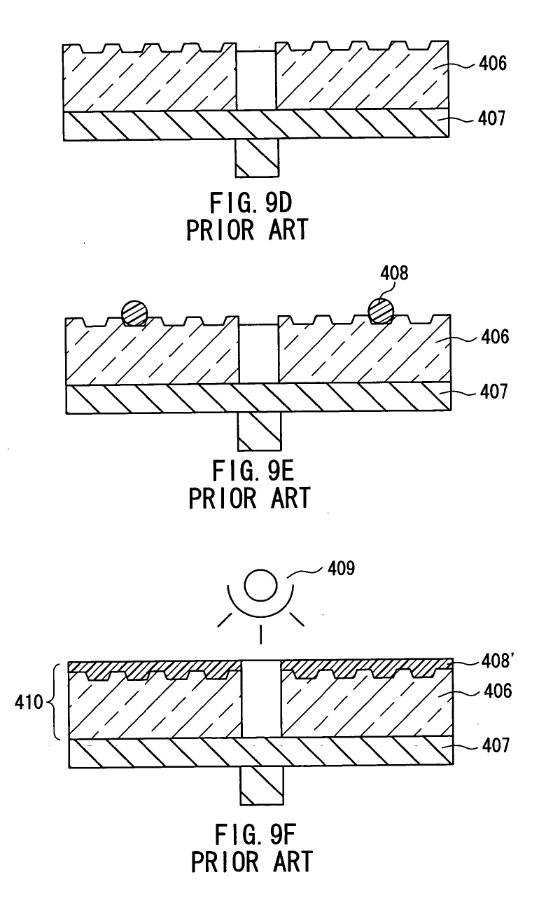

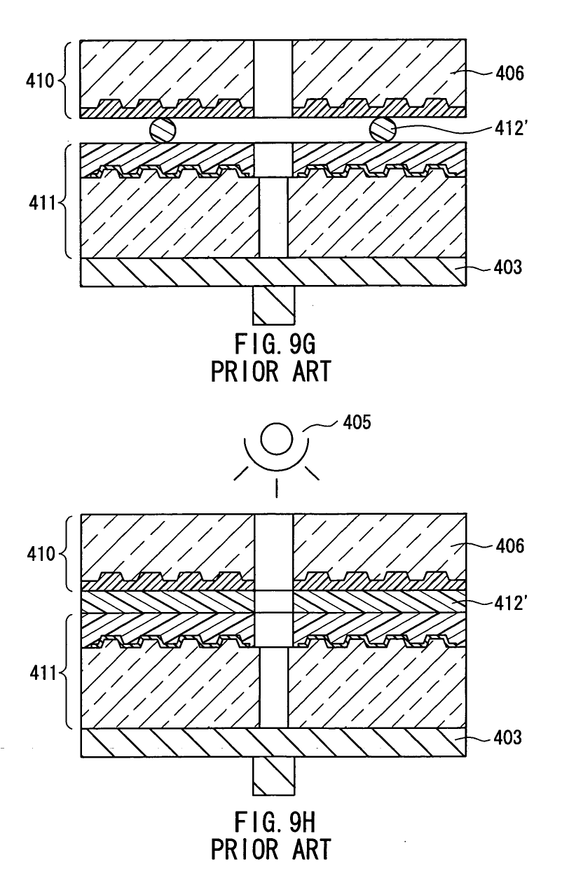

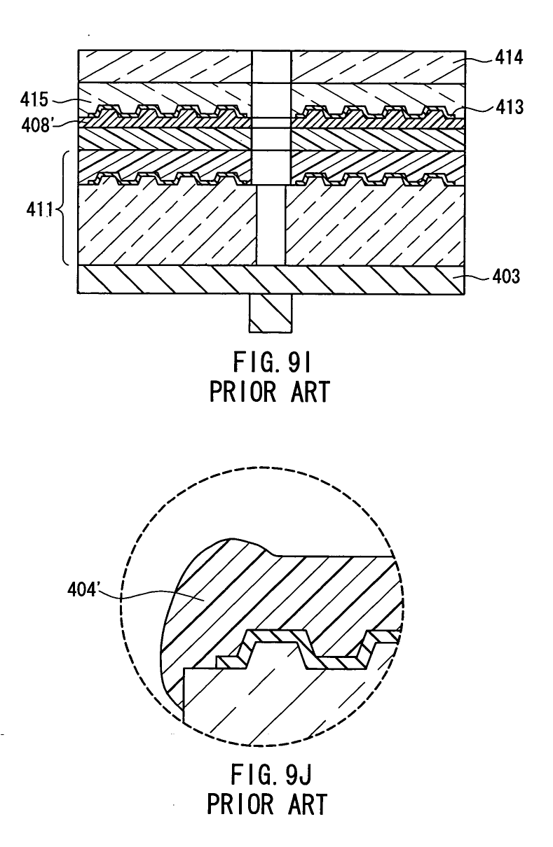

The uneven information surface is formed by molding the first signal substrate 601 using the stamper 208 shown in FIG. 7F. The first signal substrate 601 can be formed by an injection compression molding or the like, for example. The first signal substrate 601 has a center hole 610 with a diameter φ of 15 mm at its center. Through this center hole 610, the multilayer information recording medium is held rotatably at a predetermined position of a player when information is recorded/reproduced by the player.

In the case where the resin layers (second to fourth signal substrates) 603, 605 and 607 and the transparent layer 609 that are formed on the first signal substrate 601 contain a photocurable resin, a photocuring shrinkage occurs when forming these layers. This photocuring shrinkage causes the first signal substrate 601 to warp. Accordingly, it is preferable that the first signal substrate 601 is preformed to warp in the opposite direction so as to cancel the above-mentioned warp, so that no warp should occur in the multilayer information recording medium after forming the resin layers 603, 605 and 607 and the transparent layer 609.

In the case where the multilayer information recording medium according to the present embodiment is a read-only multilayer information recording medium (ROM), the first information recording portion 602 is formed of a metal or a semiconductor such as Al, Ag, Au, Si or SiO₂, or a dielectric by sputtering, vapor deposition or the like, for example.

The following is a description of the structure of the first information recording portion 602 in the case where the multilayer information recording medium according to the present embodiment is a write once-type multilayer information recording medium with reference to FIG. 2.

The first information recording portion 602 includes an AlCr reflecting film 503, a ZnS first dielectric film 504, a TeOPd recording film 505 and a ZnS second dielectric film 506 in this order from the side of the first signal substrate 601 (see FIG. 1), for example. All of these layers are formed by, for example, sputtering or vapor deposition. As the material for the reflecting film 503, a material containing a metal such as Ag or Au as a principal component may be used instead of AlCr, similarly to the read-only multilayer information recording medium.

The second information recording portion 604, the third information recording portion 606 and the fourth information recording portion 608 also have a structure similar to the first information recording portion 602. By adjusting the thickness of the reflecting film 503, removing the reflecting film 503 and/or adjusting the thickness of the first dielectric film 504 and the recording film 505, it is possible to adjust the optical characteristics of the multilayer information recording medium. Further, the first to fourth information recording portions also may have a structure further including a dye film (not shown).

The resin layer (second signal substrate) 603 is substantially transparent to recording/reproducing light. It is preferable that the resin layer 603 is formed of an ultraviolet curable resin containing an acrylic resin as a principal component, for example. This is because the ultraviolet curable resin responds with a high sensitivity only to light at wavelengths in an ultraviolet range and cures itself. Therefore, in a process of forming the resin layer 603, even if a resin-containing coating applied to the first information recording portion 602 is heated using electromagnetic waves in a wavelength range longer than the ultraviolet light, the ultraviolet curable resin contained in the resin-containing coating is not cured by these electromagnetic waves. Thus, by heating the resin-containing coating using the electromagnetic waves in the wavelength range longer than the ultraviolet light, it becomes possible to smooth out the surface of the resin-containing coating without curing the ultraviolet curable resin.

The resin layer 603 is produced as follows, for example. A resin-containing coating that contains an ultraviolet curable resin (sometimes simply referred to as a “coating”) is applied onto the first signal substrate 601 through openings in a screen for forming the resin layer 603. With an information surface of a signal transfer substrate pressed against the applied coating, the ultraviolet curable resin contained in the coating is cured using ultraviolet light. Then, the signal transfer substrate is peeled off from the cured ultraviolet curable resin. It is noted that the resin-containing coating is applied onto the first signal substrate 601 except for edge portions (an outer edge portion 601a and an inner edge portion 601b) of the first signal substrate 601. Since the first information recording portion 602 is formed on the first signal substrate 601, the coating is applied onto the first signal substrate 601 via the first information recording portion 602.

The resin layers (third and fourth signal substrates) 605 and 607 also are formed of a material similar to the resin layer (second signal substrate) 603 by a method similar thereto into a shape similar thereto.

The resin-containing coating may contain not only the resin such as the ultraviolet curable resin but also a solvent for adjusting viscosity, a cure initiator, etc.

The transparent layer 609 is substantially transparent to recording/reproducing light. It is preferable that the transparent layer 609 is formed of an ultraviolet curable resin containing an acrylic resin as a principal component, for example. The transparent layer 609 also can be formed by a method similar to the resin layer. The transparent layer 609 is formed so as to cover the first to fourth information recording portions 602, 604, 606 and 608 and the resin layers 603, 605 and 607 and, for example, partially join with the outer edge portion 601a and the inner edge portion 601b of the first signal substrate 601.

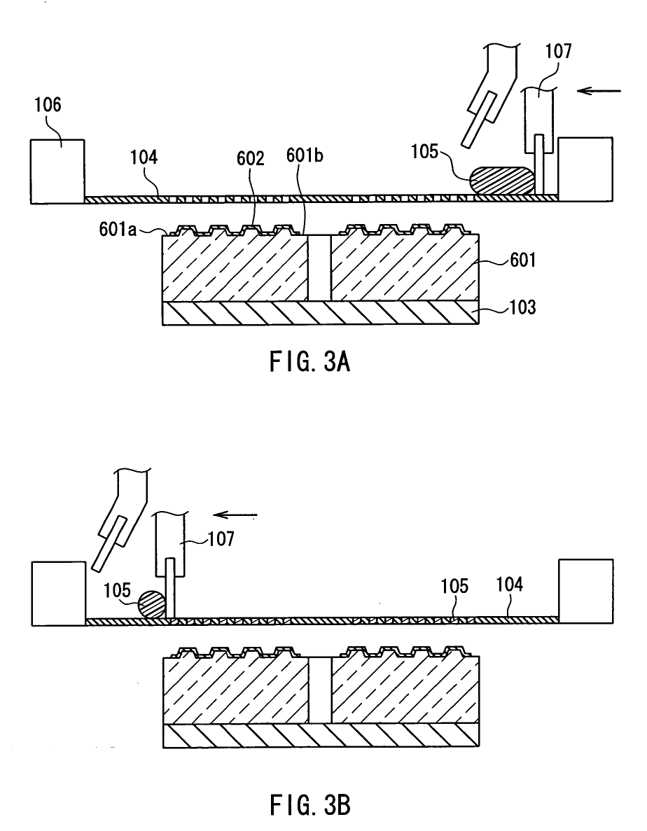

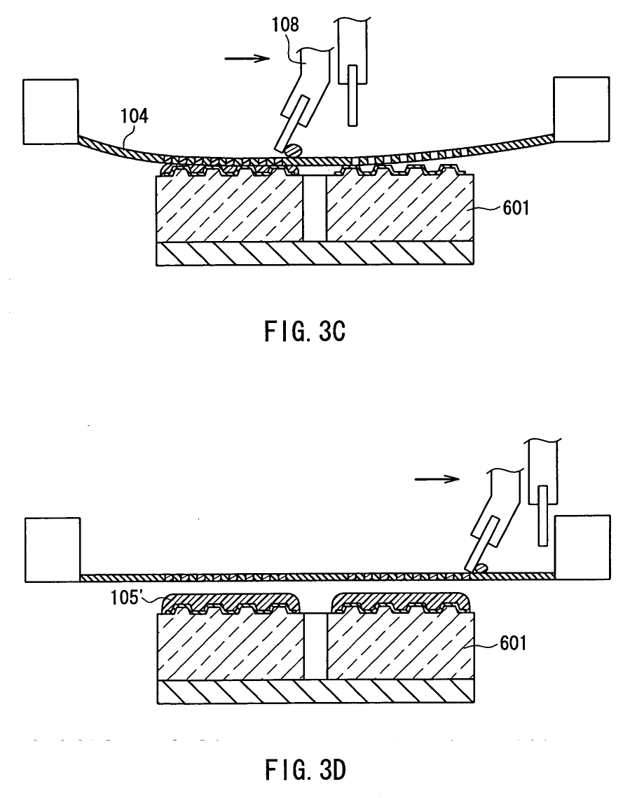

Next, an example of a method for manufacturing the multilayer information recording medium according to the present embodiment will be described referring to FIGS. 3A to 6E.

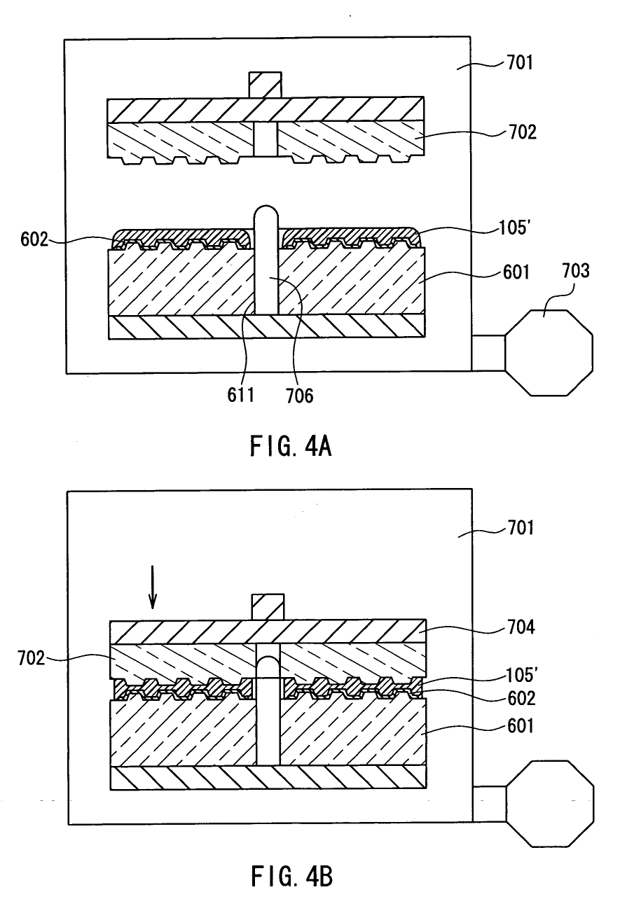

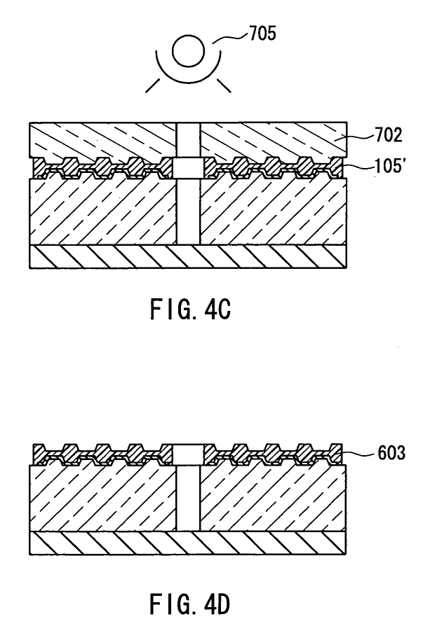

FIGS. 3A to 4D are sectional views for describing an example of the method for manufacturing the multilayer information recording medium according to the present embodiment.

In the method for manufacturing the multilayer information recording medium according to the present embodiment, first, the first information recording portion 602 including the recording film, the reflecting film, etc. is formed on the information surface of the first signal substrate 601. The recording film, the reflecting film, etc. each are formed by sputtering, vapor deposition or the like. The first signal substrate 601 is fixed to a table 103 by suction or the like arranged on the opposite side of the first information recording portion, as necessary.

Next, a screen 104 having a mesh with a predetermined dimension is arranged above the first signal substrate 601 at a predetermined distance therefrom. The screen 104 can restrict an amount of the coating to be applied appropriately and allows a uniform application when a resin-containing coating 105 that has been supplied on the surface of the screen 104 opposite to the side of the first signal substrate 601 is applied to the first information recording portion 602 through the mesh.

Now, how to produce the screen 104 will be described. First, a screen material is stretched on a screen frame 106 and coated with a photosensitive emulsion. Thereafter, parts other than predetermined positions (positions at which a plurality of openings are to be formed) in the coated screen material are covered with a light-shielding mask. The screen material is irradiated with ultraviolet light for a predetermined period using exposure equipment. Then, the photosensitive emulsion that has been exposed to light by the ultraviolet irradiation is washed with water by a water jet or the like and thus developed, thus obtaining the screen 104.

The material for the screen frame 106 can be, for example, wood, aluminum, stainless steel, plastics or the like. However, aluminum is particularly preferable because of its light weight and high rigidity. The screen material can be, for example, silk, Nylon (registered trademark), stainless steel, a resin material such as polyethylene terephthalate or the like. However, stainless steel is particularly preferable because it is not deformed very much by an external pressure. The photosensitive emulsion can be an agent obtained by mixing and dissolving a diazonium salt or a dichromate into PVA or vinyl acetate emulsion, for example. It is preferable that the mesh number (the number of threads per inch) at a predetermined position in the screen material is 150 to 600. If the mesh number falls within this range, the resin-containing coating can be applied without causing poor passage or uneven application of the resin-containing coating. Incidentally, the openings in the screen are not limited to the mesh.

TABLE 1

| | Viscosity of ultraviolet curable resin (mPa · s) | | | | | | | | | | | |
|---|---|---|---|---|---|---|---|---|---|---|---|---|
| | 5 | 10 | 20 | 30 | 40 | 50 | . . . | 3500 | 4000 | 4100 | 4200 | 4300 |
| State | Poor | Poor | Good | Good | Good | Good | . . . | Good | Good | NG | NG | Poor |

| | | | | |
|---|---|---|---|---|
| of | Resin reached end | Excellent | Thickness | Not |
| resin | faces of substrate | | became | trans- |
| layer | | | uneven | ferred |

Table 1 shows the relationship between the viscosity of the resin-containing coating and the state of the resin layer. As shown in Table 1, it was found that an excellent resin layer was formed when the resin-containing coating had a viscosity of 30 to 4000 mPa·s (30 to 4000 cps). When the resin-containing coating had a viscosity lower than 30 mPa·s (30 cps), the applied resin-containing coating slightly flowed to the end faces of the first signal substrate 601. When the resin-containing coating had a viscosity exceeding 4000 mPa·s (4000 cps), it became difficult for the resin-containing coating to pass through the openings of the screen, so it also became difficult to apply the coating. From the above, considering a decrease in the viscosity of the resin-containing coating due to the variation in temperature or humidity of the atmosphere, it is preferable that the resin-containing coating has a viscosity of 100 to 4000 mPa·s (100 to 4000 cps).

In the present application, the viscosity is a value measured using a rotating viscometer. The method of measuring the viscosity using a rotating viscometer utilizes the fact that a torque of a rotating body is proportional to the viscosity. The rotating body can be, for example, a cylindrical rotor, a blade or the like. The torque refers to a force necessary to keep the rotating body put in a sample (the resin-containing coating) rotating at a constant speed by a motor or the like connected via a rod-like shaft.

By selecting a region where the openings are formed in the screen 104, it is possible to restrict the application range of the resin-containing coating. For example, the present embodiment uses the screen 104 with a region that extends outside the inner diameter of the first signal substrate 601 (e.g., at a distance equal to or greater than 10.5 mm from the center) and inside the outer diameter thereof (e.g., at a distance equal to or smaller than 59.75 mm from the center) to which the resin-containing coating 105 can be applied (see FIG. 3A). The use of such a screen 104 makes it possible to apply the resin-containing coating 105 onto the first signal substrate 601 except for the edge portions 601a and 601b, namely, onto the region that is inside a circle with a diameter φof 119.5 mm and outside a circle with a diameter φ of 21 mm.

In the above example, the outer edge portion 601a of the first signal substrate 601 is the region from the outer perimeter extending inward by a distance smaller than 0.25 mm, and the inner edge portion 601b of the first signal substrate 601 is the region from the inner perimeter extending outward by a distance smaller than 3 mm. However, the edge portions are not limited to the above in the method for manufacturing a multilayer information recording medium in the present embodiment.

In the case where the multilayer information recording medium according to the present embodiment has, for example, an outer peripheral information signal region, it is preferable that the outer edge portion 601a of the first signal substrate 601 is located outside the outer peripheral information signal region. For example, in a Blu-ray Disc, the region located at a distance greater than 58.5 mm from the center is the outer edge portion 601a. It should be noted that information about the outer periphery of the multilayer information recording medium is recorded in the outer peripheral information signal region.

In the case where the multilayer information recording medium according to the present embodiment includes a protection ring for preventing scratches on the surface of the multilayer information recording medium inside the inner perimeter of the first signal substrate 601, for example, the inner edge portion 601b of the first signal substrate 601 refers to the region that is located outside the protection ring and inside the first information recording portion 602.

In some cases, the multilayer information recording medium according to the present embodiment has, for example, a region fixed to a spindle by a clamping mechanism (in the following, referred to as a “clamping region”) outside the protection ring. For example, in a Blu-ray Disc, the clamping region is the region located at a distance of 6.5 to 11.5 mm from the center. When the multilayer information recording medium has the clamping region, the inner edge portion 601b of the first signal substrate 601 is the region that is located inside the clamping region or the region that is a combination of the clamping region and the region inside the clamping region in the first signal substrate 601. This is because it is not preferable for the resin layer to be present not entirely but only partially above the clamping region.

The multilayer information recording medium according to the present embodiment may have, for example, an inner peripheral information signal region in which information about the inner periphery of the multilayer information recording medium is recorded. In this case, the inner edge portion 601b of the first signal substrate 601 may be located inside the inner peripheral information signal region in the first signal substrate 601, for example. In a Blu-ray disc, for example, the region located at a distance smaller than 21.0 mm from the center is the inner edge portion 601b.

As described above, in the method for manufacturing a multilayer information recording medium according to the present embodiment, in a process of forming the resin layer, the resin-containing coating is applied onto the first signal substrate except for the edge portions of this substrate through the openings of the screen. Therefore, in the resin layer, it is possible to suppress the mounding or spew of the resin above the edge portions (the outer edge portion and the inner edge portion) of the first signal substrate. This suppresses the variation in thickness of the outer edge portion and the inner edge portion and the variation in optical path therein. Consequently, it is possible to suppress the variation in light spot size due to an increase in spherical aberration, thus providing a multilayer information recording medium that allows a focusing control and a tracking control to be performed stably. Furthermore, the method for manufacturing a multilayer information recording medium according to the present embodiment can provide a multilayer information recording medium having a high dimensional accuracy and an excellent external appearance.

The resin-containing coating 105 is applied (transferred) to the first signal substrate 601 as follows. First, a scraper 107 is slid on the screen 104, thereby filling the resin-containing coating 105 into a plurality of openings of the screen 104 (see FIGS. 3A and 3B). Next, a squeegee 108 is slid on the screen 104 so as to apply a predetermined pressure thereto. In this way, the resin-containing coating filled in the openings of the screen 104 are pushed out of the openings and applied onto the first signal substrate 601 (see FIG. 3C).

It should be noted that how to apply the resin-containing coating 105 to the first signal substrate 601 is not limited to the above. Depending on the kinds of the screen 104 and the resin-containing coating, the resin-containing coating 105 easily may pass through the openings of the screen 104. In this case, simply by sliding the squeegee 108, it is possible both to fill the resin-containing coating 105 into a plurality of openings and apply it to the first signal substrate 601.

In the present embodiment, the average thickness of the resin layer is set to 10 to 25 μm, for example, so that the resultant multilayer information recording medium can record/reproduce information using a recording/reproducing head including an objective lens whose numerical aperture is 0.85 and a 405 nm wavelength laser light source. The scraper 107 and the squeegee 108 may be formed of a material such as a silicone rubber, polyurethane or stainless steel. The thickness (amount) of the resin-containing coating 105 to be applied to the first signal substrate 601 varies depending on the angle of the squeegee 108 with respect to the screen 104, the pressure applied by the squeegee 108 and the moving speed of the squeegee 108. Therefore, it is desired that the above-mentioned angle, pressure and speed be adjusted to be constant.

The resin-containing coating applied onto the first signal substrate 601 has an application pattern (a screen pattern) immediately after the application because it has been applied through the openings of the screen 104. Thus, it is preferable to allow the substrate to stand for a predetermined period after applying the resin-containing coating so as to reduce the unevenness from the application pattern on the surface of the resin-containing coating 105, thereby leveling the resin-containing coating (smoothing out the surface unevenness). Although the above-noted predetermined period varies depending on the viscosity of the resin-containing coating, it preferably is about 4 to 120 seconds in general. For example, when the viscosity of the resin-containing coating at the time of application is 30 to 4000 mPa·s, the leveling begins immediately after the application, and it takes about 4 seconds to smooth out the surface if the resin-containing coating has a relatively low viscosity and a low thixotropy. On the other hand, if the resin-containing coating has a relatively high viscosity and a high thixotropy, since it flows slowly, the leveling does not occur easily, so that it takes about 120 seconds to smooth out the surface. It should be noted that the degree of “smoothness” is sufficient as long as the first signal substrate 601 and a signal transfer substrate 702 (see FIG. 4A) can be attached to each other excellently.

Heating the applied resin-containing coating is more preferable because the leveling is accelerated. As a heating device, a far infrared heater is preferably used so as not to cure the ultraviolet curable resin contained in the resin-containing coating, for example.

TABLE 2

| Surface temperature of resin (° C.) | | | | | | | | | | | |
|---|---|---|---|---|---|---|---|---|---|---|---|
| 20 | 30 | 40 | 50 | 60 | . . . | 90 | 100 | 110 | 120 | 130 | 140 |
| Poor | NG | Good | Good | Good | . . . | Good | Good | Good | Good | NG | Poor |

| | | | |
|---|---|---|---|
| Appli- | Application | Normal | Deteriora- |
| cation | pattern | | tion |
| pattern | remained | | occurred |

Table 2 shows the relationship between the surface temperature of the resin-containing coating and how much the application pattern remained. How much the application pattern remained was observed visually. As shown in Table 2, when the resin-containing coating was heated so that the surface temperature fell within the range of 40° C. to 120° C., it was possible to remove the unevenness substantially while suppressing the deterioration of the ultraviolet curable resin, allowing an optimal leveling. Considering the deformation of the first signal substrate 601, it is more preferable that the surface temperature of the resin-containing coating is in the range of 40° C. to 100° C.

Incidentally, the surface temperature was measured using a noncontact radiation thermometer.

In this manner, by heating the applied resin-containing coating so that its surface temperature is raised to a predetermined temperature, a resin-containing coating layer 105′ with a uniform thickness can be formed speedily on the first signal substrate 601 (see FIG. 3D).

In the method for manufacturing a multilayer information recording medium according to the present embodiment, the resin-containing coating may be heated with a hot air in the middle of applying the resin-containing coating. Also, the applied resin-containing coating may be heated with a hot air. This is because the combination of heating and blowing an air makes it possible to smooth out the surface of the resin-containing coating more efficiently and effectively and suppress the entry of large air bubbles into the resin layer. It is preferable that the resin-containing coating is heated with the hot air so that its surface temperature rises to 30° C. to 100° C.

FIGS. 4A to 4D are sectional views showing an example of a method for transferring a signal to a resin-containing coating in the method for manufacturing a multilayer information recording medium according to the present embodiment. The first signal substrate 601 having one principal surface provided with the resin-containing coating layer 105′ is placed in a decompression chamber 701. The first signal substrate 601 is fixed at a predetermined position by passing a center boss 706 through a center hole 611 formed at the center of the first signal substrate 601. At the same time, a signal transfer substrate 702 also is placed in the decompression chamber 701. It is preferable that the signal transfer substrate 702 contains, for example, polyolefin, which has an excellent peelability from the ultraviolet curable resin. Since polyolefin has an excellent formability, it also is preferred as a material for the signal transfer substrate 702 in that the uneven information surface can be formed easily.

Further, since polyolefin has an ultraviolet-transmitting property, the resin-containing coating is irradiated with ultraviolet light through the signal transfer substrate 702, thereby curing the ultraviolet curable resin contained in the resin-containing coating efficiently. Such polyolefin can be, for example, cycloolefin made from cyclopentadiene.

When the average thickness of the first signal substrate 601 is, for example, 1.1 mm, that of the signal transfer substrate 702 preferably is set to 0.6 mm, for example. The use of the signal transfer substrate 702 thinner than the first signal substrate 601 makes it easy to peel off the signal transfer substrate 702 owing to the difference in rigidity caused by the difference in thickness.

The decompression chamber 701 can be exhausted by a pressure-reducing pump 703 such as a rotary pump or a mechanical booster pump and be decompressed to a predetermined pressure within a short time. In the present embodiment, when the interior of the decompression chamber 701 reaches a degree of vacuum of equal to or lower than 100 Pa, for example, the signal transfer substrate 702 and the first signal substrate 601 are attached to each other via the resin-containing coating layer 105′ and the first information recording portion 602.

At this time, the signal transfer substrate 702 is pressed with a pressing plate 704, thereby transferring the uneven surface of the signal transfer substrate 702 serving as the information surface to the resin-containing coating layer 105′. Since the interior of the decompression chamber 701 is decompressed, the signal transfer substrate 702 and the first signal substrate 601 can be attached to each other without allowing air bubbles to enter between the resin-containing coating layer 105′ and the signal transfer substrate 702 (see FIG. 4B). Moreover, it also is possible to remove the air bubbles that have entered the resin-containing coating at the time of applying the resin-containing coating 105 onto the first signal substrate 601 through the openings of the screen.

Next, the first signal substrate 601 and the signal transfer substrate 702 that are attached to each other is taken out from the decompression chamber 701. Subsequently, the resin-containing coating layer 105′ is irradiated with ultraviolet light through the signal transfer substrate 702 using an ultraviolet irradiating device 705 disposed above the signal transfer substrate 702, thereby curing the ultraviolet curable resin contained in the resin-containing coating so as to form the resin-containing coating layer 105′ into a resin layer (see FIG. 4C).

Thereafter, the signal transfer substrate 702 is peeled off from the cured ultraviolet curable resin. At this time, it is preferable to blow compressed air between the signal transfer substrate 702 and the resin layer. In this manner, the resin layer 603 having the information surface is formed (see FIG. 4D).

Next, the second information recording portion 604 is formed by sputtering or the like similarly to the first information recording portion 602. The resin layer 605 also is formed similarly to the resin layer 603. Furthermore, the third information recording portion 606, the fourth information recording portion 608 and the information layer 607 also are formed similarly. Then, the transparent layer 609 is formed on the fourth information recording portion 608. The transparent layer 609 is formed using an ultraviolet curable resin containing as a principal component an acrylic resin that is substantially transparent to (transmits) recording/reproducing light. Similarly to the resin layer, the transparent layer 609 also is formed by applying a coating for forming the transparent layer 609 to the fourth information recording portion 608 through the openings of the screen (see FIG. 1).

The average thickness of the transparent layer 609 directly above the fourth information recording portion 608 is determined according to the thickness of the resin layers 603, 605 and 607 between the transparent layer 609 and the first information recording portion 602 so that the distance from the surface of the transparent layer 609 to the first information recording portion 602 is about 100 μm. This 100 μm is a correctable limit of spherical aberration by the recording/reproducing head used in the present embodiment.

For example, in the case where the average thickness of each of the resin layers 603, 605 and 607 is 25 μm, that of the transparent layer 609 is set to 25 μm (100 μm−25 μm×3 layers). Also, in the case where the average thickness of the resin layers 603, 605 and 607 is 10 μm, that of the transparent layer 609 is set to 70 μm (100 μm−10 μm×3 layers). Incidentally, the thickness of each of the first to fourth information recording portions is incomparably smaller than that of the resin layer or the transparent layer 609 and thus is considered negligible for this purpose.

In the method for manufacturing a multilayer information recording medium according to the present embodiment, all of the resin layers 603, 605 and 607, the first information recording portion 602, the second information recording portion 604, the third information recording portion 606 and the fourth information recording portion 608 are formed on the first signal substrate 601 except for the edge portions of the first signal substrate 601 (see FIG. 1). Thus, the transparent layer 609 can be formed so as to join with the outer edge portion 601a and the inner edge portion 601b of the first signal substrate 601. Consequently, the first information recording portion 602, the second information recording portion 604, the third information recording portion 606, the fourth information recording portion 608 and the resin layers 603, 605 and 607 can be surrounded by the transparent layer 609 and the first signal substrate 601. Polycarbonate has a high adhesiveness to an ultraviolet curable resin that has not been cured and a cured ultraviolet curable resin. Therefore, the use of polycarbonate as the material for the first signal substrate 601 and an ultraviolet curable resin as that for the transparent layer 609 suppresses the peeling of the resin layer and the information recording portion from each other owing to moisture or the like.

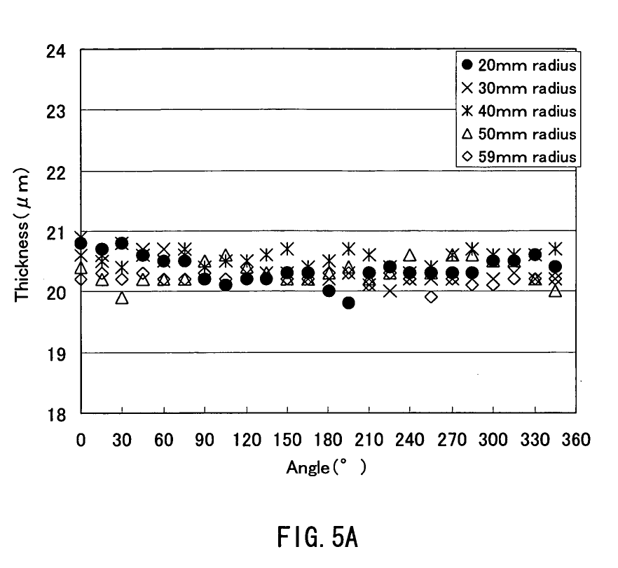

FIG. 5A shows a result of measuring the thickness of the resin layer in the multilayer information recording medium produced by the method for manufacturing a multilayer information recording medium according to the present embodiment, and FIG. 5B shows a result of measuring the thickness of a resin layer constituting a conventional multilayer information recording medium. The thickness of the resin layer was measured at 15° intervals on each of concentric circles with a radius of 20 mm, 30 mm, 40 mm, 50 mm and 59 mm whose center corresponds to the center of the multilayer information recording medium. In other words, the thickness of the resin layer was measured at 120 points that did not overlap each other.

The thickness of the resin layer was measured by a method utilizing the interference effect of light (a PV method). This measurement method utilizes the following property of light: light reflected by the front surface of the resin layer and light reflected by the back surface thereof interfere with each other, so that the light intensity increases if the phases of these reflected lights match and the light intensity lowers if they differ. An interference pattern in which the intensity of the reflected light varies with wavelength is observed. Based on the relationship that a peak wavelength λ1 and a valley wavelength λ2 in this pattern are an integral multiple of an optical path difference 2nd (n=the refractive index of the resin layer, d=the thickness of the resin layer), the thickness d of the resin layer can be obtained.

The thickness of the resin layer is measured by a laser beam having a wavelength longer than the laser beam used for recording/reproducing information with respect to the multilayer information recording medium. If a light source emitting a light beam having a wavelength equivalent to the laser beam for recording/reproducing information with respect to the multilayer information recording medium is used in equipment for measuring the thickness of the resin layer, diffraction of light is generated by the information recorded in the information recording portion and adversely affects the measurement of the thickness of the resin layer. For example, in the case of using a blue laser beam with a wavelength of about 400 nm as a recording/reproducing laser beam, a red laser beam with a wavelength of about 650 nm is used to measure the thickness of the resin layer.

In the case where the resin layer was formed so as to have a target average thickness of 20 μm, the variation in thickness fell within ±1 μm in the multilayer information recording medium according to the present embodiment as shown in FIG. 5A. On the other hand, as shown in FIG. 5B, the variation in thickness of the resin layer was larger than ±1 μm in the conventional multilayer information recording medium. Further, when an average thickness of the resin layer denotes an average of values obtained by measuring a thickness of the resin layer at 120 points that do not overlap each other, the difference between a maximum and a minimum of the values of the thickness of the resin layer was not greater than 10% of the above-noted average thickness.

In the above description, the resin-containing coating was applied onto the first signal substrate 601 except for the edge portions of first signal substrate 601, and the first signal substrate 601 and the signal transfer substrate 702 were attached to each other via the applied resin-containing coating at a pressure lower than atmospheric pressure, thereby forming the resin layer 603 having the information surface. However, the method for manufacturing a multilayer information recording medium according to the present embodiment is not limited to this. For example, the resin-containing coating may be applied onto the signal transfer substrate 702 except for edge portions of the signal transfer substrate 702, and the first signal substrate 601 and the signal transfer substrate 702 may be attached to each other via the applied resin-containing coating at a pressure lower than atmospheric pressure, thereby forming the resin layer having the information surface.

Further, for example, when it is difficult to form a resin layer with a desired thickness using a resin-containing coating having a relatively low viscosity, a first resin-containing coating may be applied onto the signal transfer substrate 702 except for the edge portions of the signal transfer substrate 702 through openings of a first screen, a second resin-containing coating may be applied onto the first signal substrate 601 except for the edge portions of the first signal substrate 601 through openings of a second screen, and the first signal substrate 601 and the signal transfer substrate 702 may be attached to each other via the resin-containing coatings at a pressure lower than atmospheric pressure, thereby forming the resin layer having the information surface. The first screen and the second screen each may be similar to the screen 104 described referring to FIGS. 3A to 3D.

The compositions of the first resin-containing coating and the second resin-containing coating may be the same or different. In the case where the first and second resin-containing coatings respectively contain a photocurable resin and an adhesive resin (for example, an acrylic copolymer), the content of the photocurable resin in the first resin-containing coating may be set higher than that in second resin-containing coating, and/or the content of the adhesive resin in the second resin-containing coating may be set higher than that in first resin-containing coating in order to improve the peelability of the resin layer from the signal transfer substrate 702 and/or improve the adhesiveness of the resin layer to the first signal substrate 601, for example.

### Embodiment 2

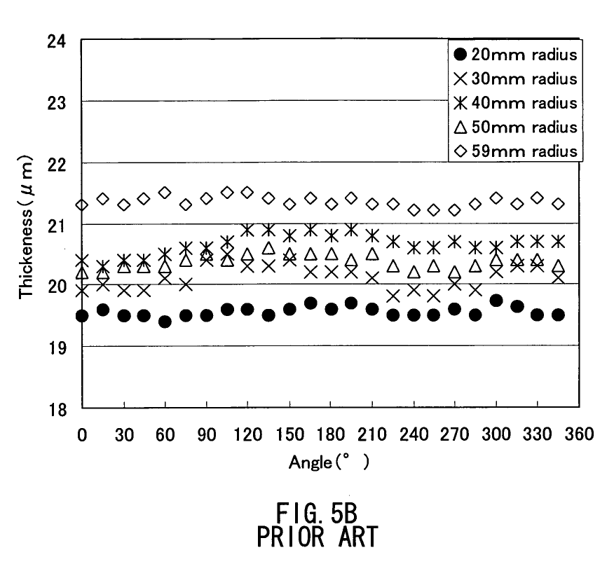

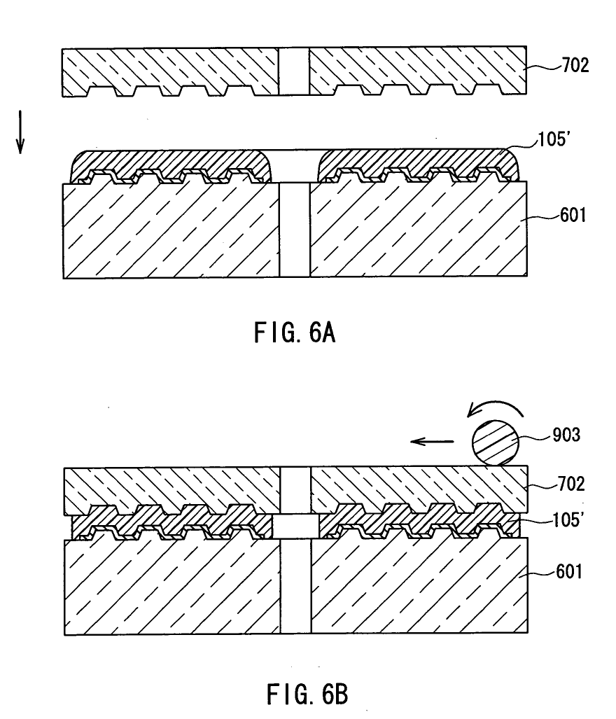

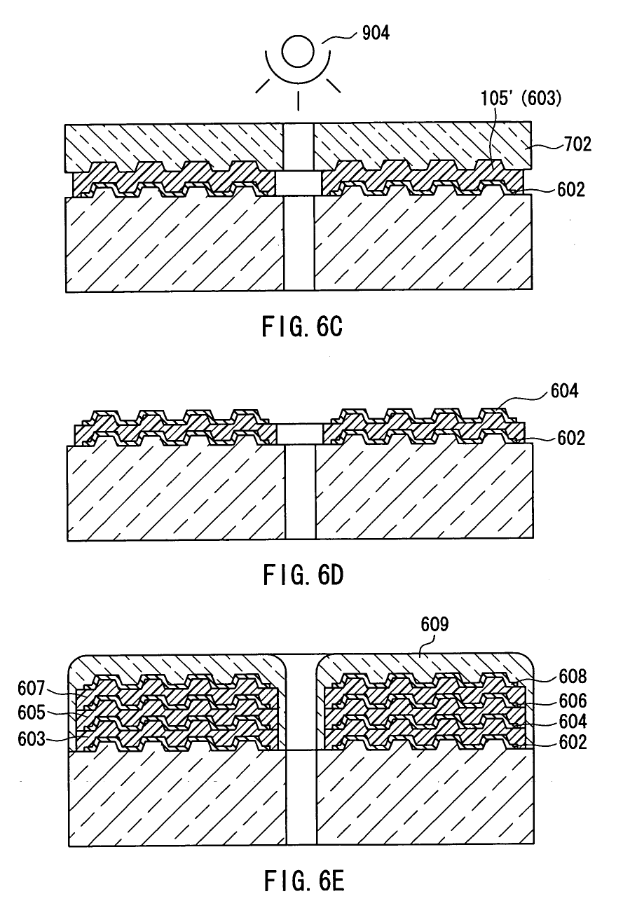

In Embodiment 2, another example of the method for manufacturing a multilayer information recording medium according to the present invention will be described referring to FIGS. 6A to 6E.

FIGS. 6A and 6B are sectional views showing how a signal is transferred to the resin-containing coating layer 105′ using the signal transfer substrate 702. By a method similar to that in Embodiment 1, the signal transfer substrate 702 is attached to the resin-containing coating layer 105′ applied onto the first signal substrate 601 (see FIG. 6A). A cylindrical roller 903 is arranged on the signal transfer substrate 702, and run rotationally thereover, thereby pressing the signal transfer substrate 702 (see FIG. 6B). In this manner, after attaching the first signal substrate 601 and the signal transfer substrate 702 to each other, by pressing the signal transfer substrate 702 with a pressing system (the roller 903) while running the pressing system (the roller 903) over the signal transfer substrate 702, it is possible to transfer the signal to the resin-containing coating layer 105′ excellently.

In the case where the roller 903 includes a heating system, the roller 903 may be run over the signal transfer substrate 702 while pressing and heating the signal transfer substrate 702, as necessary. This transfers the signal to the resin-containing coating layer 105′ even more excellently. This is because the ultraviolet curable resin that has not been cured achieves a lower viscosity when heated, allowing easy and excellent transfer of minute shapes of grooves and pits.

It is preferable that the pressing with the roller 903 is carried out at 30 to 100 kgf/cm² (29.4×10⁵ to 98.1×10⁵ Pa). Although the transferability improves with an increase in the pressure applied to the signal transfer substrate 702, an excessive pressure causes the warping of the multilayer information recording medium and/or the variation in thickness of the resin layer. If the pressure is within the above-mentioned range, it is possible to transfer the signal excellently without causing the warping of the multilayer information recording medium or the variation in the resin layer thickness.

It is preferable that the surface temperature of the roller 903 is 25° C. to 100° C. An excessively high temperature causes the deterioration of a resin layer and/or the warping of the multilayer information recording medium. If the surface temperature of the roller 903 is within the above-mentioned range, it is possible to perform the excellent signal transfer without causing the deterioration of the resin layer or the warping of the multilayer information recording medium.

Air bubbles contained in the resin-containing coating layer 105′ can be reduced by pressing with the roller 903. However, it is preferable to place the first signal substrate 601 provided with the first information recording portion 602 and the signal transfer substrate 702 in the decompression chamber 701 and then attach them to each other inside the decompression chamber 701. This makes it possible to remove air bubbles that have entered when applying the resin-containing coating and reduce air bubbles that enter at the time of attaching the first signal substrate 601 and the signal transfer substrate 702 to each other.

Next, using an ultraviolet irradiator 904 disposed above the signal transfer substrate 702, the resin-containing coating layer 105′ is irradiated with irradiation light through the signal transfer substrate 702, thereby curing the ultraviolet curable resin contained in the resin-containing coating layer 105′. In the present embodiment, the material for the signal transfer substrate 702 is a polyolefin resin that is substantially transparent to the above-noted irradiation light similarly to Embodiment 1 (see FIG. 6C).

Subsequently, the signal transfer substrate 702 is peeled off from the cured resin-containing coating layer 105′ (the resin layer 603). At this time, if compressed air is blown between the signal transfer substrate 702 and the resin layer 603, the signal transfer substrate 702 can be peeled off from the resin layer 603 easily while maintaining the joint between the first information recording portion 602 and the resin layer 603.

Thereafter, the second information recording portion 604 also is formed by sputtering or the like similarly to the first information recording portion 602 (see FIG. 6D). The resin layer 605 also is formed similarly to the resin layer 603. Further, the third information recording portion 606, the fourth information recording portion 608 and the resin layer 607 also are formed similarly. Next, the transparent layer 609 is formed on the fourth information recording portion. The transparent layer 609 also may be formed similarly to Embodiment 1 (see FIG. 6E).

Although Embodiments 1 and 2 both have illustrated the multilayer information recording medium including four information recording portions, the multilayer information recording medium and the method for manufacturing the same according to the present invention are not limited to this. The number of the information recording portions may be set to two, three, five, or more by adjusting the thicknesses of the first signal substrate, the resin layer and the transparent layer. An information recording medium including a plurality of information recording portions is capable of recording/reproducing large volumes of information.

Although the first to fourth information recording portions in Embodiments 1 and 2 all include the reflecting film 503, the first dielectric film 504, the recording film 505 and the second dielectric film 506 in this order from the side of the first signal substrate (see FIG. 2), the first to fourth information recording portions are not limited to this structure. As long as each of the information recording portions includes at least a recording film, at least one of the remaining films may be omitted or any film other than these films may be included.

By taking a disc-like so-called Blu-ray Disc as an example, Embodiments 1 and 2 have explained that the resin-containing coating is applied onto the first signal substrate 601 except for the outer edge portion 601a and the inner edge portion 601b of the first signal substrate 601. However, the multilayer information recording medium and the method for manufacturing the same according to the present invention are not limited to the above. For example, in the case of a multilayer information recording medium without a center hole 610, such as a memory card, the resin-containing coating may be applied onto the first signal substrate 601 except for only the outer edge portion of the first signal substrate.

As described above, in accordance with the present invention, it is possible to provide a multilayer information recording medium with respect to which information is recorded or reproduced excellently and that achieves an excellent production efficiency, and a method for manufacturing the same.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A method for manufacturing a multilayer information recording medium having a signal substrate, at least two information recording portions disposed on the signal substrate and a resin layer disposed between the information recording portions adjacent to each other, the method comprising forming the resin layer, the forming of the resin layer including:
applying a resin-containing coating onto the signal substrate except for an edge portion of the signal substrate through openings of a screen;
attaching the signal substrate and a signal transfer substrate to each other via the applied resin-containing coating at a pressure lower than atmospheric pressure;
curing a resin contained in the applied resin-containing coating to form the resin layer; and then
peeling off the signal transfer substrate from the resin layer.

2. A method for manufacturing a multilayer information recording medium having a signal substrate, at least two information recording portions disposed on the signal substrate and a resin layer disposed between the information recording portions adjacent to each other, the method comprising forming the resin layer, the forming of the resin layer including:
applying a resin-containing coating onto a signal transfer substrate except for an edge portion of the signal transfer substrate through openings of a screen;
attaching the signal substrate and the signal transfer substrate to each other via the applied resin-containing coating at a pressure lower than atmospheric pressure;
curing a resin contained in the applied resin-containing coating to form the resin layer; and then
peeling off the signal transfer substrate from the resin layer.

3. A method for manufacturing a multilayer information recording medium having a signal substrate, at least two information recording portions disposed on the signal substrate and a resin layer disposed between the information recording portions adjacent to each other, the method comprising forming the resin layer, the forming of the resin layer including:
applying a first resin-containing coating onto a signal transfer substrate except for an edge portion of the signal transfer substrate through openings of a first screen;
applying a second resin-containing coating onto the signal substrate except for an edge portion of the signal substrate through openings of a second screen;
attaching the signal substrate and the signal transfer substrate to each other via the first and second resin-containing coatings at a pressure lower than atmospheric pressure;
curing a resin contained in the first resin-containing coating and a resin contained in the second resin-containing coating to form the resin layer; and then
peeling off the signal transfer substrate from the resin layer.

4. The method according to claim 1, wherein in the forming of the resin layer, the signal substrate and the signal transfer substrate are attached to each other after a predetermined period of time since the resin-containing coating is applied.

5. The method according to claim 1, wherein the forming of the resin layer further including heating the applied resin-containing coating after applying of the resin-containing coating and before attaching the signal substrate and the signal transfer substrate to each other.

6. The method according to claim 5, wherein the applied resin-containing coating is heated so that its surface temperature rises to 40° C. to 120° C.

7. The method according to claim 5, wherein the applied resin-containing coating is heated so that its surface temperature rises to 40° C. to 100° C.

8. The method according to claim 1, wherein the forming of the resin layer further including heating the resin-containing coating with a hot air in the middle of applying the resin-containing coating.

9. The method according to claim 5, wherein the applied resin-containing coating is heated with a hot air.

10. The method according to claim 9, wherein the applied resin-containing coating is heated so that its surface temperature rises to 30° C. to 100° C.

11. The method according to claim 1, wherein the resin contained in the resin-containing coating comprises a photocurable resin.

12. The method according to claim 11, wherein the photocurable resin comprises an ultraviolet curable resin.

13. The method according to claim 12, wherein the forming of the resin layer further including heating the applied resin-containing coating with an electromagnetic wave in a wavelength range longer than ultraviolet light after applying of the resin-containing coating and before attaching the signal substrate and the signal transfer substrate to each other.

14. The method according to claim 1, wherein the resin-containing coating to be applied has a viscosity of 30 to 4000 mPa·s.

15. The method according to claim 1, wherein the resin-containing coating to be applied has a viscosity of 100 to 4000 mPa·s.

16. The method according to claim 1, wherein the forming of the resin layer further including pressing the signal transfer substrate with a pressing system after attaching the signal substrate and the signal transfer substrate to each other and before curing the resin contained in the applied resin-containing coating.

17. The method according to claim 11, wherein the signal transfer substrate is transparent to an irradiation light used for curing the resin, and
the resin-containing coating is irradiated with the irradiation light through the signal transfer substrate, thus curing the resin.

18. The method according to claim 1, wherein the signal transfer substrate comprises a polyolefin resin.

19. The method according to claim 1, wherein the signal substrate is a disc having a center hole, and the resin-containing coating is applied onto the signal substrate except for an outer edge portion and an inner edge portion of the signal substrate.

20. A multilayer information recording medium manufactured by the method according to claim 1.

21. A multilayer information recording medium comprising:
a signal substrate;
at least two information recording portions disposed on the signal substrate; and
a resin layer disposed between the information recording portions adjacent to each other;
wherein when an average thickness of the resin layer denotes an average of values obtained by measuring a thickness of the resin layer at 120 points that do not overlap each other, a difference between a maximum and a minimum of the values of the thickness of the resin layer is not greater than 10% of the average thickness.
